(19) United States
(12) Patent Application Publication
(10) Pub. No.: US 2018/0365925 A1
(43) Pub. Date: Dec. 20, 2018

(54) METHOD AND APPARATUS FOR AUTOMATIC REFUELING CONFIGURATION

(71) Applicant: FORD GLOBAL TECHNOLOGIES, LLC, Dearborn, MI (US)

(72) Inventors: Justin Reuel BADGER, Plymouth, MI (US); Ted HALADYNA, Northville, MI (US)

(21) Appl. No.: 15/626,861

(22) Filed: Jun. 19, 2017

(51) Int. Cl. G07F 15/00; H04L 29/08; G06Q 20/40

(52) U.S. Cl. CPC G07F 15/001; H04L 67/12; G06Q 20/405; H04L 67/306; H04L 67/141

(57) ABSTRACT

A system includes a processor configured to determine a unique vehicle identity. The processor is also configured to communicate with a remote database to access a vehicle profile based on the unique identity. The processor is further configured to obtain user-designated refueling preferences from the remote database and apply the refueling preferences to a current refueling transaction.

### TECHNICAL FIELD

The illustrative embodiments generally relate to methods and apparatuses for automatic refueling configuration.

### BACKGROUND

Consumers have come to expect an ever-increasing degree of convenience in their daily transactions. The modern version of this trend began with the convenience of credit cards and debit cards, allowing consumers to digitally access funding without having to write a check or produce cash. Online shopping took convenience to a whole new level, allowing consumers to purchase goods without ever having to leave their homes.

This trend towards convenience has begun to appear in other places as well, including at merchant locations where quick-pass devices (fobs, phone RFID, etc) have replaced credit cards in some transactions, speeding along an already relatively fast process.

Typically, however, regardless of how fast a consumer can pay for a product, the consumer still has to spend time choosing the product and choosing a payment method. Opportunities for improving the speed of transactions exist outside the space of speeding up the actual exchange portion of the transaction.

### SUMMARY

In a first illustrative embodiment, a system includes a processor configured to determine a unique vehicle identity. The processor is also configured to communicate with a remote database to access a vehicle profile based on the unique identity. The processor is further configured to obtain user-designated refueling preferences from the remote database and apply the refueling preferences to a current refueling transaction.

In a second illustrative embodiment, a system includes a processor configured to establish communication with a fuel providing entity. The processor is also configured to access a vehicle-associated profile including refueling preferences. The processor is further configured to transmit the refueling preferences to the fuel providing entity. Also, the processor is configured to receive indication that refueling is complete and authorize payment for the completed refueling.

In a third illustrative embodiment, a computer-implemented method includes automatically configuring a fuel pump to dispense a fuel grade and use a payment method dictated by a vehicle profile, responsive to wirelessly obtaining the grade and payment method information from a remote source, storing the profile, based on a unique vehicle identification made by a pump-associated computing system.

### BRIEF DESCRIPTION OF THE DRAWINGS

FIG. 1 shows an illustrative vehicle computing system;

FIG. 2 shows an illustrative pump-side process for facilitating refueling; and

FIG. 3 shows an illustrative example of a device/vehicle/server side process for use with the illustrative embodiments.

### DETAILED DESCRIPTION

As required, detailed embodiments are disclosed herein; however, it is to be understood that the disclosed embodiments are merely illustrative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

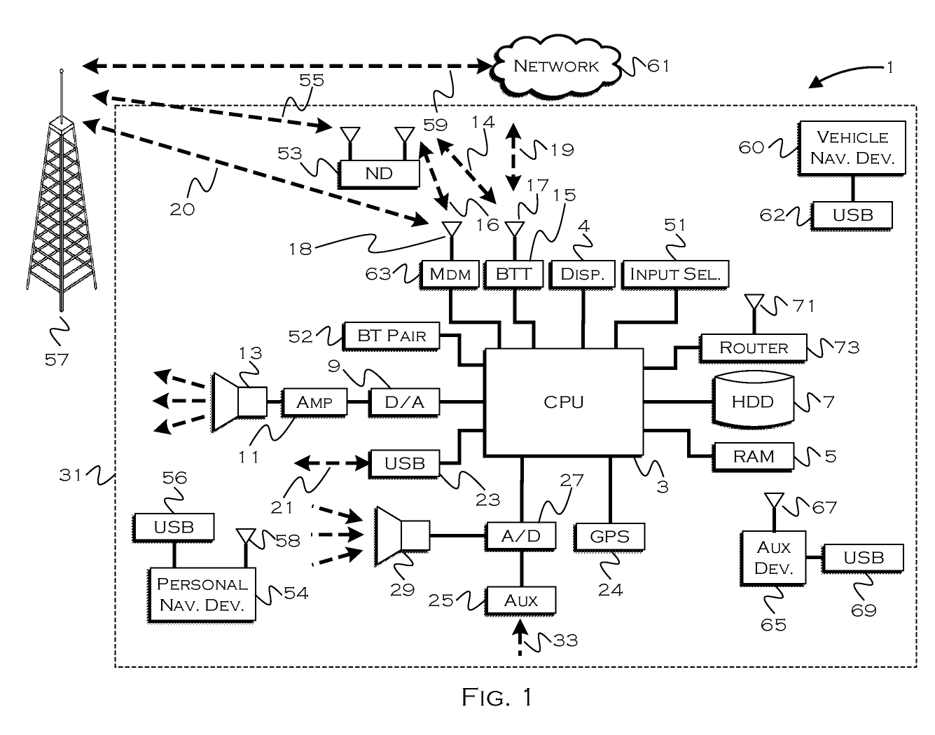

FIG. 1 illustrates an example block topology for a vehicle-based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a Wi-Fi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 g network (i.e., Wi-Fi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle-based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments relate to use of pre-defined consumer preferences for fuel and payment to facilitate fuel selection and payment selection. The definitions of both fuel and payment preferences can be tied to a user account (related to a phone, for example) or a vehicle identification (related to a vehicle, for example). In another instance, the vehicle may store accounts for multiple users, and/or the phone may store preferences for an owner coupled with multiple vehicles (different fuel grades per vehicle, for example, or different payment solutions per vehicle).

For example, a user driving a performance automobile for fun on the weekend may want a high grade of fuel, paid for with a personal card. The same person may want a lower grade of fuel, paid for with a company card, if driving a company vehicle. Since the phone, vehicle and pump can all cross-communicate, using at least the illustrative embodiments, the selection of fuel and payment solutions can be done automatically when the particular user arrives at a pump, without any user interaction needed, in many cases.

Through the illustrative embodiments, a vehicle or phone can detect when it is proximate to a pump, and can communicate with a particular pump to establish user preference selection for both payment and fuel. The same can be accomplished using a phone and the pump, and the illustrative embodiments can be executed via a phone application, vehicle application or vehicle and phone application acting in concert.

In other embodiments, the pump or station detects the arrival of a vehicle and, for example, communicates with the vehicle to determine vehicle identification information, communicates with a device to determine user and vehicle identification information, or communicates with the cloud after visually identifying a vehicle (e.g., license plate).

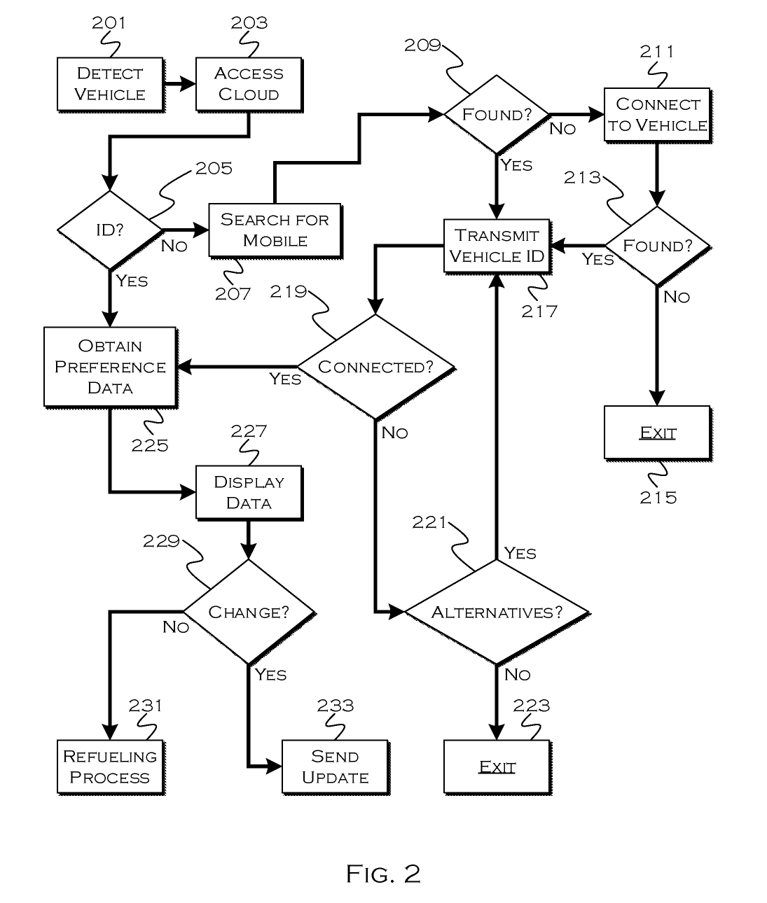

FIG. 2 shows an illustrative pump-side process for facilitating refueling. In this example, the pump or station determines 201 that a vehicle has arrived at a pump. This can be accomplished, for example, by a close range wireless transmission with a vehicle-embedded chip, close range communication with a user device, visual identification of a unique vehicle characteristic or other suitable unique identification of the vehicle. A correlation of GPS coordinates between the location of the pump and vehicle is also possible.

In the example where the pump detects a vehicle identity wirelessly, for example, the pump may communicate with the vehicle or receive a signal from a vehicle device. This data may be simple unique identification of the vehicle, or the data could include preferred fuel and/or payment selection. If the pump communicates with a user device, the user device could store preferences for all vehicles, or for different vehicles, and could identify the vehicle to the pump (if needed) based on communication between the device and the vehicle (whereby preferences and/or vehicle ID can be obtained).

The process can access 203 a cloud-storage of unique vehicle profiles and corresponding preference settings associated with the profiles. In other examples, the process may access user profiles and select a profile setting associated with a specific vehicle, the vehicle and setting also identified in the profile.

The process may determine 205 if a vehicle identification results in a cloud-match, providing user-preference data. If the obtained identification results in no usable vehicle data, the process may search 207 for a mobile signal and/or search 211 for a vehicle wireless connection (e.g., BLUETOOTH low energy—BLE). If the process finds 209 a mobile device signal or finds 213 a vehicle connection, the process may transmit 217 the determined vehicle identification to the mobile device or the vehicle connection(s). Since the mobile device and/or vehicle will have knowledge of the owner's vehicle identity, only the connections that verify a match between the transmitted ID and a stored ID will be used for obtaining preference data.

It is also possible to obtain a vehicle ID through direct communication with the mobile device and/or vehicle. Since refueling stations typically have more than one pump, there may be some secondary considerations if the process is searching for a local wireless connection to obtain an ID. In the case of visual identification, or RFID identification, a localized determination can typically be made, which includes relative assurances that the vehicle identified is the actual vehicle at the present pump. If the process searches for a wireless connection, for example, the process may detect a number of possible connections. Various sorts can be used to rule out incorrect devices and or narrow the field of candidate connections. This can include, for example, sending a connection request that has to be fielded via a device display (e.g., “PUMP 7 WOULD LIKE TO CONNECT TO YOUR VEHICLE, PLEASE CHECK YOUR PUMP NUMBER AND CONFIRM OR REJECT THIS REQUEST), or coupling device/vehicle GPS data with pump location data (and/or vehicle heading data, coupled with knowledge of the fuel inlet side) to determine candidate signals/devices. In another example, a user may be asked to affirmatively enter a pump number, to ensure that the user is at the requesting pump.

If the process transmits a vehicle ID (already determined) to a mobile device or vehicle wireless connection, and the mobile device or vehicle wireless connection confirms that the connection corresponds to the vehicle identified by the process, the process may establish a connection. If the process is still not connected 219, the process may try additional available wireless connections 221 to attempt to establish a proper connection. Failure to obtain a connection may result in the pump ignoring preferences and functioning as normal 223.

If the process establishes a connection with the local device, vehicle or cloud, and the entity communicating with the pump has preference data stored thereon, the process may obtain 225 the preference data from the entity. This could include, for example, obtaining preference data for a vehicle from a vehicle profile stored in the cloud, on a device or on the vehicle, obtaining preference data for a user based on a vehicle setting stored in a user profile (where the setting identifies the vehicle), or obtaining preference data for a user based on a user correlation to a mobile device or vehicle and wherein the user preference data is used for all vehicles associated with that user (no distinction is made between vehicles).

The process may then display 227 (on the pump screen) the data so the user is aware of the selected preferences. In other examples, not shown, the process may transmit the data for in-vehicle or on-device display. The user may then input 229 any changes to the automatically selected data, or the pump can proceed as pre-selected.

If the user does not input a change, the refueling process may simply proceed 231. If the user inputs a change (to payment, fuel type, etc), the process may implement the change and report 233 the change back to whatever source provided the preference data originally.

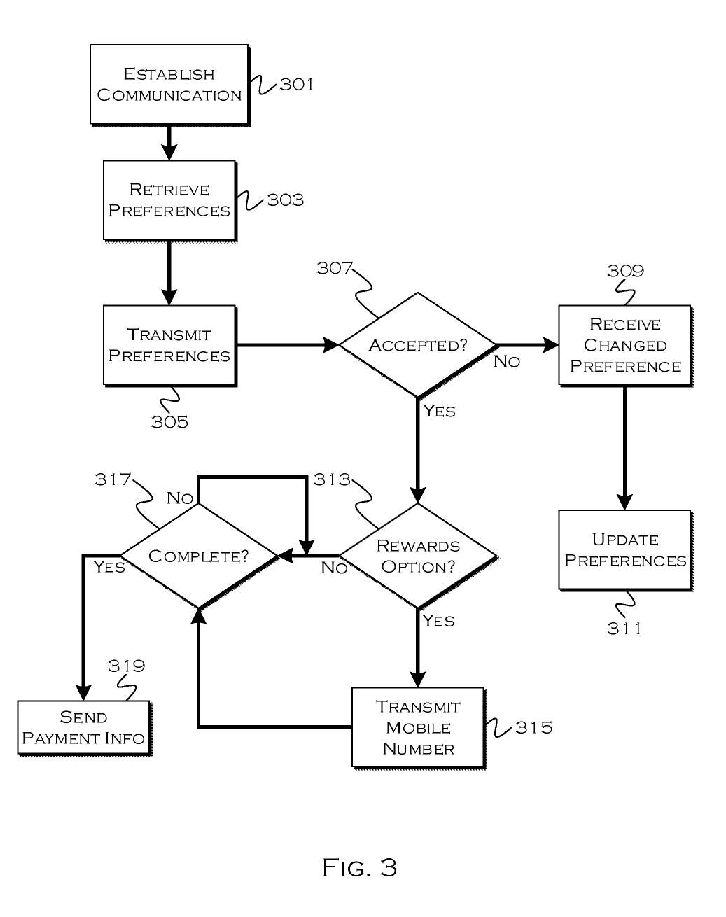

FIG. 3 shows an illustrative example of a device/vehicle/server side process for use with the illustrative embodiments. In this example, the process establishes communication 301 with the refueling point. The process may receive (or may have already received) a vehicle or user identifying indicator, and based on this indicator the process can retrieve 303 a stored set of user/vehicle preferences. These preferences may include fuel type designations, payment designations, cost caps, etc. For example, a parent could set up a child account for automatic payment, but may also impose a weekly cost-cap on fuel. This cap could be transmitted to the pump in the form of a maximum amount of fuel (in terms of dollars) to be dispensed. The process may retrieve and transmit 305 any suitable predefined preferences for a user, vehicle or user+vehicle combination.

If the preferences are retrieved from a mobile device or vehicle computer, the mobile device or vehicle computer may also display the transmitted preferences, giving a user an opportunity to change the automatic selections. The process may update the preferences based on the user selections, which can include a learning process (wherein the most-selected or a number of most-recently selected choices dictate the automatic choice) or the user can explicitly specify a default choice, and then chose another option if the situation dictates.

If the user accepts 307 the default automatic preferences, the process may continue to step 313 to check for a fuel rewards option. If the user wants to change a selection, the process receives a change 309 along with an indicator (if desired) as to whether the selection represents a new permanent choice or a one-time change. If the system engages in learning, or if the user indicates a new primary preference, the process may then update 311 the stored preferences.

At step 313 the process determines if the fuel station includes a reward point option. If there is an opportunity to use reward points, the process may transmit 315 a mobile number or other user-identity indicator (user_id, password or code, etc). The user can also configured default settings for reward usage, such as, for example, only use rewards if the tank is more than N % empty. The user can then engage in vehicle refueling. Once the refueling is complete 317, the process can deliver 319 payment information (which can be stored on any connected device—cloud, vehicle, mobile phone, etc.). In another embodiment, the pump can transmit the total cost to the device/vehicle/cloud, and payment can process without the payment information itself being transferred.

The same payment and selection process can be done for gasoline or electric fuel, where the preferences for electricity include, for example, fast-charging vs. normal charging. If the manufacturer includes recommendations (do not fast charge more than 30% of the time, or always use premium fuel), these recommendations may be accommodated by automatic variation of selections (e.g., automatically selecting premium or normal charging if fast charging is used too frequently), and the user may need to explicitly override manufacturer suggestions to have different defaults used.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a processor configured to:
determine a unique vehicle identity;
communicate with a remote database to access a vehicle profile based on the unique identity;
obtain user-designated refueling preferences from the remote database; and
apply the refueling preferences to a current refueling transaction.

2. The system of claim 1, wherein the refueling preferences include a type of payment.

3. The system of claim 1, wherein the refueling preferences include a type of fuel.

4. The system of claim 1, wherein the processor is configured to determine the unique vehicle identity based on visual identification of a license plate.

5. The system of claim 1, wherein the processor is configured to determine the unique vehicle identity based on identification included in a wireless signal received from a vehicle-embedded device.

6. The system of claim 1, wherein the processor is configured to determine the unique vehicle identity based on information included in a wireless signal received from a mobile phone.

7. The system of claim 1, wherein the processor is configured to transmit the preferences to a vehicle.

8. The system of claim 7, wherein the processor is configured to receive a change to the transmitted preference information from a vehicle.

9. The system of claim 1, wherein the processor is configured to change applied refueling preferences to match the changed preference information received from the vehicle.

10. The system of claim 9, wherein the processor is configured to transmit the changed preference information to the remote database.

11. A system comprising:
a processor configured to:
establish communication with a fuel providing entity;
access a vehicle-associated profile including refueling preferences;
transmit the refueling preferences to the fuel providing entity;
receive indication that refueling is complete; and
authorize payment for the completed refueling.

12. The system of claim 11, wherein the processor is included in a remote server.

13. The system of claim 12, wherein the processor is configured to authorize payment by transmitting payment information usable to complete a transaction.

14. The system of claim 12, wherein the processor is configured to authorize payment by receiving a total cost of refueling and transacting payment based on the total cost and a stored payment-form, without transmitting the payment information to the fuel providing entity.

15. The system of claim 11, wherein the processor is included in a vehicle.

16. The system of claim 15, wherein the processor is configured to display the refueling preferences on a vehicle display, and receive user-alteration of a preference, and wherein the processor is configured to transmit the refueling preferences reflecting the alteration.

17. The system of claim 11, wherein the processor is included in a mobile device.

18. The system of claim 17, wherein the processor is configured to display the refueling preferences on a mobile device display, and receive user-alteration of a preference, and wherein the processor is configured to transmit the refueling preferences reflecting the alteration.

19. A computer-implemented method comprising:
automatically configuring a fuel pump to dispense a fuel grade and use a payment method dictated by a vehicle profile, responsive to wirelessly obtaining the grade and payment method information from a remote source, storing the profile, based on a unique vehicle identification made by a pump-associated computing system.

20. The system of claim 19, wherein the remote source is one of a cloud-server, a vehicle computer or a mobile phone.
